(19) United States
(12) Patent Application Publication
(10) Pub. No.: US 2026/0014503 A1
(43) Pub. Date: Jan. 15, 2026

(54) OPEN SLOT HELICAL CHANNEL INERTIAL FILTER

(71) Applicant: IRPI LLC, Wilsonville, OR (US)

(72) Inventors: Logan J. Torres, Hillsboro, OR (US); Ryan M. Jenson, Happy Valley, OR (US); Mark M. Weislogel, Newberg, OR (US); Oleg Krishcko, Vancouver, WA (US)

(21) Appl. No.: 19/267,124

(22) Filed: Jul. 11, 2025

Related U.S. Application Data
(60) Provisional application No. 63/671,570, filed on Jul. 15, 2024.

(51) Int. Cl. B01D 45/16; B01D 45/04; B01D 53/18

(52) U.S. Cl. CPC B01D 45/16; B01D 45/04; B01D 53/18

(57) ABSTRACT

Methods and systems are provided for a multiplexed phase-separating inertial filter that is composed of helical passages that generate centrifugal separating forces. In one example, the multiplex inertial filter may include a housing with a hollow internal structure; and an array of helical passages, where each helical passage of the array of helical passages includes an open slot in a wall of the helical passage, and the open slot fluidly couples a flow path of the helical passage to the hollow internal structure of the housing.

### CROSS REFERENCE TO RELATED APPLICATIONS

The present application claims priority of U.S. Provisional Application No. 63/671,570 entitled “OPEN SLOT HELICAL CHANNEL INERTIAL FILTER”, and filed on Jul. 15, 2024. The entire contents of the above-listed application are hereby incorporated by reference for all purposes.

### GOVERNMENT SUPPORT

This invention was made with Government support under Contract No. 80NSSC20C0247 and 80NSSC22CA225 awarded by the National Aeronautics and Space Administration. (NASA). The Government has certain rights in the invention.

### FIELD

The present description relates generally to liquid, gas, and/or solid phase separating filters.

### BACKGROUND/SUMMARY

Numerous challenges are faced by the designers of life support systems for spacecraft because of the persistently unfamiliar and unforgiving low-gravity (low-g) environment. A common challenge is the collection (e.g., filtration) of liquid droplets and solid particles from gas streams. Solid-gas and liquid-gas phase separations of dust, mists, sprays, etc. are pervasive and desired in numerous engineering systems (e.g., liquid-gas sorbent chemistry, filtration, heating ventilation and air conditioning (HVAC), demisters, firefighting equipment, and others). Such systems are often directly tied to life support systems such as oxygen supply, air revitalization, thermal management systems, water reclamation, medical fluids, and so on. Prior solutions include active separators and fine filters, both of which possess serious shortcomings of complexity and pressure drop. Active separators involve moving parts, which are disadvantageous due to added potential points of degradation that reduce reliability while increasing mass, power consumption, and noise. Fine filters also involve significant drawbacks that include high pressure drops due to the tortuous and low open area of such filters, as well as increasing pressure drop as saturation increases.

In a low-g environment, particulates pose a persistent challenge. It is desirable to filter and separate particulate matter having different sizes and shapes (e.g., large and small). On Earth, gravity does a significant amount of passive work to separate particulates by size. Large particles fall to the ground quickly, while smaller particles eventually settle to the ground in time. In 1-g environments (e.g., on Earth), a relatively small mass load is sufficient to separate particles by size, as large particles settle due to gravity. In a low-g environment, gravity does not settle any particles, regardless of size. Thus, in low-g environments, traditional filtration systems have a large mass load. In a low-g environment and in environments where there is a relatively short distance to the ground, it is desirable to filter all particle sizes, which may present a potentially large load. Thus, a filter that does not use moving parts and which is configured to filter a broad range of particle sizes is desired.

In order to at least partially address the issues described above, a filter described herein is configured as a multiplex inertial filter, and comprises a housing with a hollow internal structure; and an array of helical passages, where each helical passage of the array of helical passages includes an open slot in a wall of the helical passage, and the open slot fluidly couples a flow path of the helical passage to the hollow internal structure of the housing. The helical passages generate a centrifugal separating force that aids in separation of liquids and/or solid particles from gas (e.g., solid-gas separation, liquid-gas separation) and/or from each other (e.g., liquid-liquid separation, liquid-solid separation). A helix shape of the helical passage enables particles and/or liquids to be thrown towards walls of the helical passage, pass through the open slot in the wall of the helical passage, and become trapped within the hollow internal structure of the housing. Two or more multiplex inertial filters may be stacked to form a filter system, where each multiplex inertial filter of the filter system has helical passages with a progressively smaller pore diameter compared to a pore diameter of the helical passages of an immediately preceding multiplex filter. In this way, particles may be captured from a liquid and/or gas flow by one or more multiplex inertial filters of the filter system. In filter systems formed of multiple stacked multiplex inertial filters, captured particles may be sorted by size. The multiplex inertial filter may also include a packing material that enables liquid-liquid separation.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a perspective view of a multiplex inertial filter.

FIG. 2 shows a perspective view and a side view of a helical passage of the multiplex inertial filter.

FIG. 3 shows exemplary configurations of helical passages of the multiplex inertial filter.

FIG. 4 shows an exploded view of a first configuration of the multiplex inertial filter.

FIG. 5 shows an exploded view of a second configuration of the multiplex inertial filter.

FIG. 6 shows an exploded view of a filter system comprising a stack of multiplex inertial filters.

FIG. 7 shows a cross-section view of the stack of multiplex inertial filters.

FIG. 8 shows a perspective view and an exploded view of a vacuum device comprising the multiplex inertial filter.

FIG. 9 shows a cross-section view of the multiplex inertial filter of the vacuum device.

FIG. 10 shows a cross-section view of the vacuum device.

### DETAILED DESCRIPTION

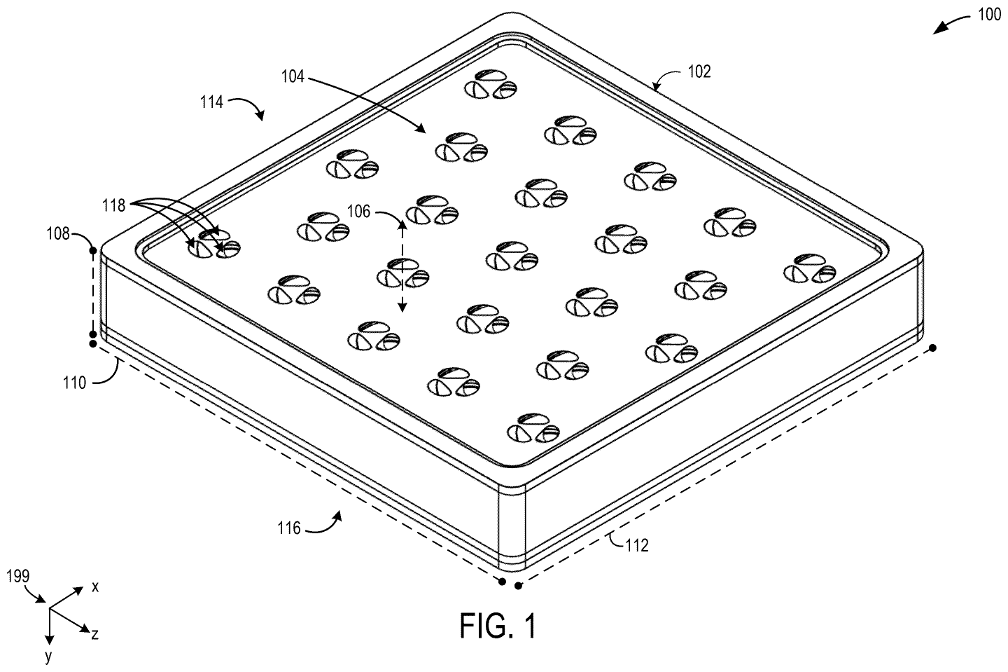

The following description relates to systems and methods for a multiplex phase separating inertial filter, also referred to herein as a multiplex inertial filter. Helical passages of the multiplex inertial filter direct multiphase flow containing particles and/or liquid droplets through directional changes that subject the air flow to the force of inertia. The difference of kinetic energy of particles of different sizes and masses helps to separate the particles from the air flow. The multiplex inertial filter described herein is configured to filter and capture particles of a broad range of sizes from the air flow. The helical passages may have different configurations that enable different filtering of particles. The multiplex inertial filter may be used independently, in a filter system comprising a stack of two or more multiplex inertial filters, and/or integrated in a device such as a vacuum device. A hollow internal structure of the multiplex inertial filter may comprise horizontal baffles that segment the hollow internal structure into individual regions surrounding and separating each helical passage. Different configurations of the multiplex inertial filter that may be stacked to form a filter system configured to separate captured particles by size. FIGS. 1-10 are shown approximately to scale.

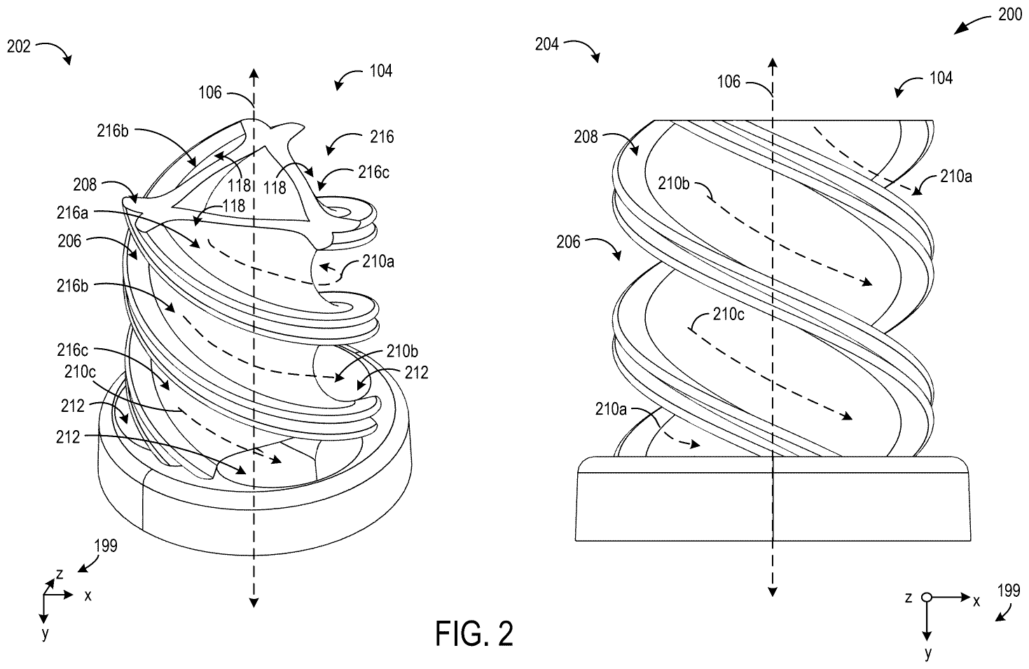

FIG. 1 shows a perspective view of a multiplex inertial filter 100. The multiplex inertial filter 100 may be configured for use in low-g environments, such as in space and/or on a lunar surface. The multiplex inertial filter 100 may provide helical configurations, pore densities, and/or slot structures that are appropriate for filtering dust composed of media of different sizes, such as lunar dust or other particulate matter. An axis system 199 is provided in FIG. 1, as well as FIGS. 2-7, for reference. The z-axis may be a vertical axis, the x-axis may be a lateral axis (e.g., horizontal axis), and the y-axis may be a longitudinal axis, in one example. However, the axes may have other orientations, in other examples.

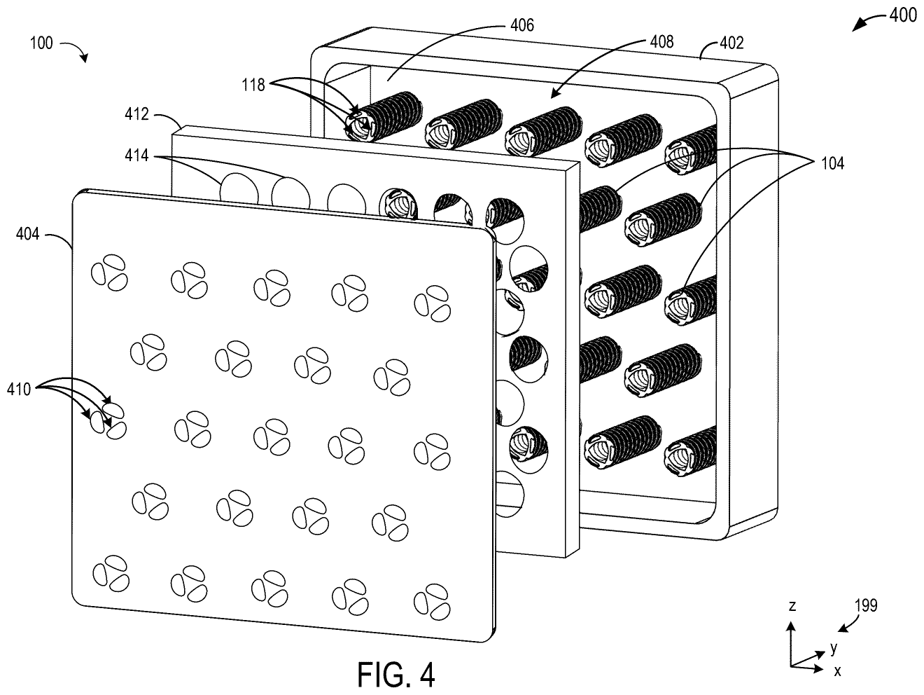

The multiplex inertial filter 100 comprises a housing 102 with a hollow internal structure, and an array of helical passages 104. An example configuration of the multiplex inertial filter 100 provided in FIG. 1 is substantially rectangular in shape with a height 108, a length 110 that is perpendicular to the height 108, and a width 112 that is perpendicular to both the height 108 and the length 110. The array of helical passages 104 may protrude into the hollow internal structure of the housing 102, as is further described with respect to FIG. 4. Each helical passage 104 may be arranged parallel to the height 108 of the multiplex inertial filter 100, wherein inlets 118 of the helical passage 104 are positioned at a first side 114 (parallel to the z-x plane) of the multiplex inertial filter 100, outlets (not shown in FIG. 1) of the helical flow path are positioned at a second side 116 (parallel to the z-x plane) of the multiplex inertial filter 100, opposite the first side 114, and the helical flow path(s) of the helical passage 104 direct flow from the inlets 118 to the outlets. Each helical passage 104 may be a tubular void within a porous material used to form the multiplex inertial filter 100. Each helical passage 104 may be a tri-helix unit, where three independent helical flow paths are arranged around a central axis 106 (e.g., the central axis 106 parallel to the y-axis). In other examples, the helical passages 104 may be a single helix unit, a dual helix unit (e.g., bi-helical), a quad-helix unit, and so on. Each helical passage 104 may have a number of inlets 118 that is equal to the number of independent helical flow paths. Each helical passage 104 may have a number of outlets that is equal to the number of independent helical flow paths. In the tri-helix unit example of FIG. 1, each helical passage 104 comprises three inlets 118 and three outlets (not shown in FIG. 1). One or more helical passages 104 may have a number of inlets 118 and/or outlets that is greater than or less than the number of independent helical flow paths, in some examples, without departing from the scope of the present disclosure. For example, helical flow paths of a helical passage may converge and share an inlet and/or an outlet. In some examples, the height 108 of the multiplex inertial filter 100 and a height of the helical passages 104, parallel to the height 108 of the multiplex inertial filter 100, may be 3 mm.

The multiplex inertial filter 100, including one or more of the helical passages 104 and/or the housing 102, may be formed via additive manufacturing (e.g., three-dimensional (3D) printing). Generally, any 3D-printing methods may be used to form the multiplex inertial filter 100. For example, fused deposition modeling (FDM), fused filament fabrication (FFF), stereolithography (SLA), selective laser sintering (SLS), and/or direct metal laser sintering (DMLS) may be used. The multiplex inertial filter 100 described herein may be formed by a SLA/masked SLA (mSLA) resin process to print the helical passages 104 with open slots to provide particulate and/or liquid transport into the hollow internal structure. The same mSLA resin process may be used to form the housing 102. For example, the housing 102 and the helical passages 104 may be composed of Accura 60.

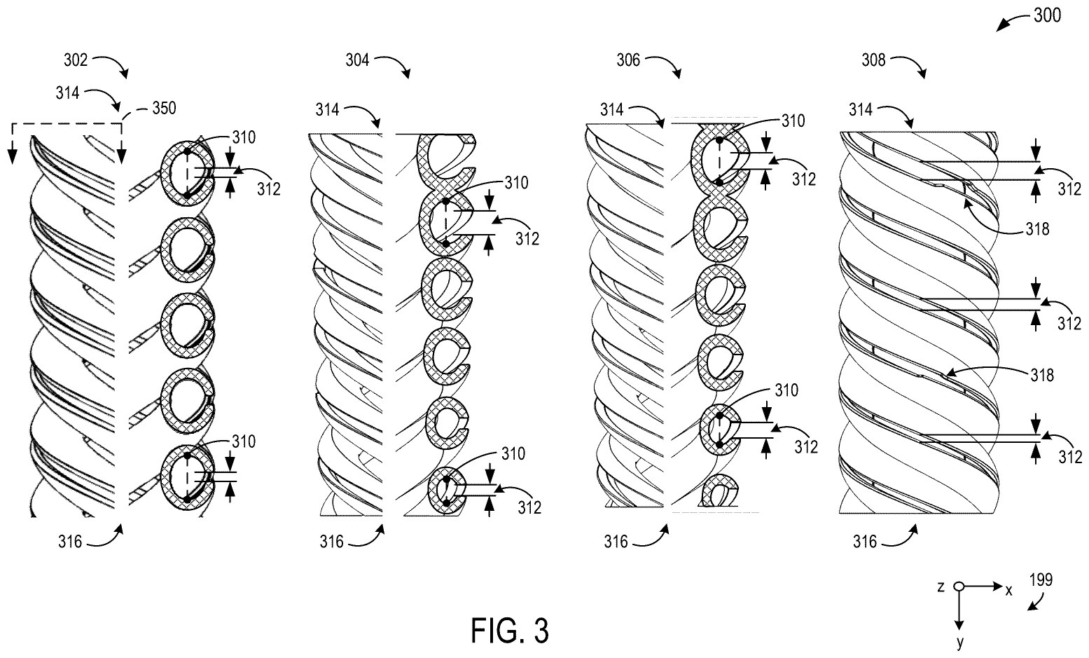

FIG. 2 shows detailed views 200 of a helical passage 104 of the multiplex inertial filter 100. The detailed views 200 include a perspective view 202 and a side view 204. Each helical passage 104 of the array of helical passages 104 is configured for centrifugal phase separation. The helical passage 104 generates a centrifugal separating force that aids in separation of liquids and solid particles. Each helical flow path of the helical passage 104 extends from a respective inlet 118 to an outlet 212. For example, FIG. 3 shows the helical passage 104 having three helical flow paths 216 (e.g., a first helical flow path 216a, a second helical flow path 216b, and a third helical flow path 216c). Each of the three helical flow paths 216 may include the inlet 118, which may be independent of the inlet 118 of the other helical flow paths of the three helical flow paths. Further, each of the three helical flow paths 216 may include the outlet 212, which may be independent of the outlet 212 of the other helical flow paths of the three helical flow paths. Flow directed from the inlet 118 to the outlet 212 of, and by, the first helical flow path 216a is illustrated by a first dashed line 210a, with the arrow thereof indicating the direction of flow. Flow directed from the inlet 118 to the outlet 212 of, and by, the second helical flow path 216b is illustrated by a second dashed line 210b, with the arrow thereof indicating the direction of flow. Flow directed from the inlet 118 to the outlet 212 of, and by, the third helical flow path 216c is illustrated by a third dashed line 210c, with the arrow thereof indicating the direction of flow.

Each helical flow path 216 may maintain an equal radial distance from the central axis 106 (e.g., a distance from the central axis parallel to an x-y plane of the reference axes). In other examples, the radial distance between the central axis 106 and one or more of the helical flow paths, and/or within a single helical flow path, may fluctuate about the central axis 106. For example, the radial distance for each turn may be different, or, as another example, the radial distance may be similar for some turns and different for others. As a further example, the radial distance may alternate between two or more different radii. Counter-rotating tri-helical structures may also accomplish similar increases in particulate capture and retention. Each helical flow path 216 of the helical passage 104 may complete one and a half rotations, where a rotation is a 260 degree turn; however, any number of rotations may be used. For example, the first, second, and third helical flow paths may complete 1, 2, 3, or more rotations, respectively, and the rotations may be full or partial rotations (e.g., 0.25, 0.50, 0.75, etc.). More rotations or fewer rotations may be added or removed by changing a pitch (e.g., a height of one full helix turn, measured parallel to the central axis 106) or by increasing a length (e.g., from the inlet 118 to the outlet 212) of the helical flow path.

Each helical passage 104 of the array of helical passages 104 may include an open slot 206 in a wall 208 of the helical passage 104. In some examples, one or more helical flow paths may have an open slot 206 in a wall 208 thereof, while other helical flow paths of the helical passage 104 may not have an open slot 206 in a respective wall 208. The open slot 206 fluidly couples the respective helical flow path 216 to the hollow internal structure of the housing 102 (shown in FIGS. 1, 4, 5, and 7). For example, the open slot 206 allows for particles and/or liquid to be thrown towards walls 208 of the respective helical flow path, fall into the open slot 206, and become trapped within the hollow internal structure of the housing 102. The hollow internal structure of the housing 102 is configured to capture and contain particles separated by the helical passages 104. Where the helical passage 104 is configured as a single helix unit, a dual helix unit (e.g., where the helical passage 104 is bi-helical), a tri-helix unit, and so on, at least one wall 208 of the helical passage 104 includes the open slot 206. For example, walls 208 of each of the three helical flow paths of the tri-helix unit shown in FIG. 2 may include the open slot 206. In other examples, walls 208 of one or two of the three helical flow paths of the tri-helix unit may include the open slot 206.

A combination of liquids, gases, and/or solids may enter the helical passage 104, through the inlet 118 (e.g., enter each helical flow path of the helical passage 104 via a respective inlet). As the liquids, gases, and/or solids pass through the helical passage 104 (e.g., flow along the helical flow paths), the liquids and/or solids may impinge on, transverse, and/or pass through the open slot 206 in the wall 208. The open slot 206 in the wall(s) 208 enable inertially centrifuged liquid to leave the helical passage 104 and enter the hollow internal structure. The open slot 206 further provides a path for solid particles to pass out of the helical flow path 216 of the helical passage 104 into the hollow internal structure of the housing 102. The helical flow path 216 may direct a main air flow, and the hollow internal structure may include low (e.g., less than the helical flow path 216) or no air flow. The low/lack of air flow in the hollow internal structure may trap the particles in the housing 102. Further, the hollow/cartridge nature of the multiplex inertial filter 100 allows for separation, capture, and containment of particulate matter into the hollow internal structure.

The multiplex inertial filter 100 is configured to capture a wide range of particle sizes. A size, thickness, volume, and several other parameters of a helical passage 104 and/or the array of helical passages 104 may be varied to adjust a pressure drop, capture efficiency, and volume containment of the multiplex inertial filter 100. Configuration of the multiplex inertial filter 100 enables precise construction of the helical passages 104 and provides a flexibility in material choices and packing options.

FIG. 3 shows various examples 300 of helical passage geometry of the multiplex inertial filter 100, where geometry of the helical passage 104 is configured to accommodate particles of various sizes, such as lunar dust particles. For brevity, “the helical passage 104” as described herein with respect to FIG. 3 is to be understood as including one or more helical flow paths (e.g., three helical flow paths, as described with respect to FIG. 2). Different examples of the multiplex inertial filter 100 may include variations in pore diameter (dₚ). A pitch (P) may be varied independent of and/or according to pore diameter to allow for a tightly coiled tri-helix. Other variables, such as number of helix units, helix diameter, and wall width, may be fixed or may be variable, depending on a desired configuration of the multiplex inertial filter 100. A trade-off between higher pressure drop (deltaP) for smaller pore diameter and tighter coiling is expected in return for higher capture efficiencies.

A first configuration 302, a second configuration 304, and a third configuration 306 of the helical passage 104 are shown in a partial cross-section. A right side of each of the first configuration 302, the second configuration 304, and the third configuration 306 shows a left side of the respective configuration as sectioned in the x-y plane, as is shown for example by a dashed line 350 for the first configuration 302. In the first configuration 302 of the helical passage 104, a pore diameter 310 and a slot width 312 are constant. Thus, the first configuration 302 shows no axial variation. In the second configuration 304, the slot width 312 of the open slot 206 is variable and the pore diameter 310 is variable for each turn of the helical passage 104. For example, moving from a first end 314 (e.g., coplanar with the first side 114 of the multiplex inertial filter 100) to a second end 316 (e.g., coplanar with the second side 116 of the multiplex inertial filter 100), opposite the first end 314, the pore diameter 310 decreases, and the slot width 312 decreases. In the third configuration 306, the slot width 312 of the open slot 206 is constant and the pore diameter 310 is variable for each turn of the helical passage 104. For example, moving from the first end 314 to the second end 316, the pore diameter 310 decreases. In a fourth configuration 308, the slot width 312 of the open slot 206 is variable and the pore diameter 310 is constant for each turn of the helical passage 104. For example, moving from the first end 314 to the second end 316, the slot width 312 decreases. The slot width 312 may decrease gradually from the first end 314 to the second end 316. In other examples, such as is shown in the fourth configuration 308 of FIG. 3, the slot width 312 may decrease in a stepwise manner, where the slot width 312 of a helical flow path is larger closer to the first end 314 relative to the slot width 312 of the helical flow path closer to the second end 316. The slot width 312 may decrease at a step 318.

In some configurations of the multiplex inertial filter 100, all helical passages of the array of helical passages 104 have the same configuration (e.g., are all the first configuration 302, or are all the second configuration 304, etc.). In other configurations, the array of helical passages 104 of the multiplex inertial filter 100 may include a variety of configurations. For example, some helical passages 104 of the array of helical passages 104 may have the second configuration 304, while other helical passages 104 of the array of helical passages 104 may have the fourth configuration 308. Configurations of the helical passages 104 may be chosen during manufacturing of the multiplex inertial filter 100, and different combinations of the configurations of the helical passages 104 may be used in the multiplex inertial filter 100 to achieve different solid-gas, liquid-gas, liquid-liquid, liquid-solid, and so on, separation.

FIG. 4 shows an exploded view 400 of the multiplex inertial filter 100. The housing 102 may be formed of a first piece 402 and a second piece 404. In some examples, the array of helical passages 104 and the first piece 402 of the housing 102 are formed as a single, continuous piece. In other examples, the array of helical passages 104 may be integral with the first piece 402 of the housing 102, such as via welding, snap-fitting, gluing, or other coupling method. Each helical passage 104 may be an individual piece that is inserted into and/or independently coupled to the first piece 402 of the housing 102 to form the array of helical passages. In another example, the array of helical passages 104 may be coupled to the first piece 402 of the housing 102 as a singular unit. The array of helical passages 104 may extend from a face 406 of the first piece 402 into a hollow internal structure 408 of the housing 102 (e.g., the central axis 106 may be parallel to the y-axis). The second piece 404 may be configured to mate with the first piece 402 to enclose the hollow internal structure 408 of the housing 102. The second piece 404 may include an array of helical through-holes 410 that complement the array of helical passages 104. For example, the helical through-holes 410 may be examples of and/or may axially overlap (e.g., parallel to the y-axis) with the inlets 118 of the array of helical passages 104, in such a way that enables uninterrupted flow through from the helical through-holes 410 to the inlets 118.

The hollow internal structure 408 of the housing 102 may be filled with one or more of a variety of materials configured to capture liquid, gas, and/or solid particles. In an assembled configuration of the multiplex inertial filter 100, a packing material 412 may be positioned in the hollow internal structure 408 between the first piece 402 and the second piece 404, and may individually surround each helical passage 104. In the example of FIG. 4, the packing material 412 is shown as a foam insert. The packing material 412 may be configured with an array of cutouts 414 that are the same in number, size, and position as the array of helical passages 104. For example, the array of cutouts 414 may be laser cut such that the packing material 412 may fit into the space between the helical passages 104 of the array of helical passages 104. In other examples of the multiplex inertial filter 100, the packing material 412 may be packing particulate, media, and so on.

The packing material 412 may be configured to capture liquid that is directed out of the helical passages 104 and into the hollow internal structure 408. The packing material 412 may be enclosed by the housing 102 such that liquid entering the helical passages 104 is absorbed by the packing material 412 and may not exit the housing 102. Placement of the packing material 412 in the hollow internal structure 408 enables droplets to be wicked into the packing material 412. The open slot 206 may selectively restrict where liquid may interact with the packing material 412, offering flexibility in types of packing material 412 used.

The packing material 412 may be an absorbent material and/or a reactive material. For example, the packing material 412 may be wetting to absorb liquid, and/or the packing material 412 may be wetting and absorbing to capture liquid and react. The packing material 412 may be a wetting foam insert or any material insert configured to enhance liquid, gas, and/or particle capture. For example, the wetting foam insert may be configured to absorb liquids. The packing material 412 may provide wicking and holding of the liquid, and may further provide capture of gas and/or liquid, and gas/liquid chemical reactions, phase changes, and/or thermal reactions. The packing material 412 may be a felt that is highly wetting to most aqueous liquids, and has a high liquid carrying capacity. In other examples, the packing material 412 may be non-wetting, hydrophobic, or superhydrophobic (e.g., at least partially liquid-rejecting). Liquid-rejecting packing material may be used to separate liquid droplets that are wetting and non-wetting. Further, liquid-rejecting packing material 412 may be used to separate immiscible liquids, where the packing material 412 is configured to absorb one liquid and reject another liquid, thus providing immiscible liquid phase (e.g., liquid-liquid) separation. For example, the packing material 412 may reject some droplets and absorb others depending on wetting properties of the liquid. The hollow internal structure 408 may be purged, cleaned, and/or replaced to remove captured particles and/or liquid therefrom, and may be reused for future capture. Further, the packing material 412 may be purged, cleaned, and/or replaced to remove captured particles and/or liquid therefrom, and may be reused for future capture.

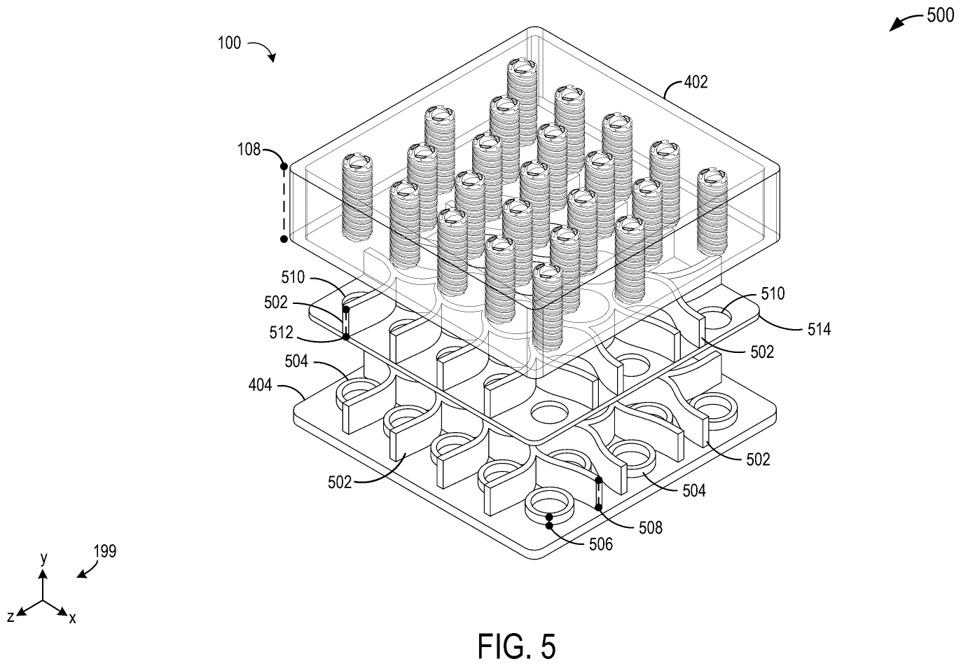

In some examples, the multiplex inertial filter 100 further comprises dividers and other aspects integrated into the housing 102 to reduce bleeding of air into the hollow internal structure 408 and to reduce transfer of particles between individual helical passages 104 (e.g., between a first helical passage of the array of helical passages 104 and a second helical passage of the array of helical passages 104). FIG. 5 shows an example configuration 500 of the multiplex inertial filter 100 in an exploded view. In the configuration 500 of FIG. 5, the second piece 404 of the housing 102 includes horizontal baffles 502 that segment the hollow internal structure 408 into individual regions surrounding each helical passage 104 that fluidly separate each helical passage 104 from other helical passages 104 of the array of helical passages 104. The horizontal baffles 502 may isolate helical passages 104 and prevent crosstalk. The horizontal baffles 502 may extend parallel to the y-axis, and at least partially along the height 108 of the multiplex inertial filter 100.

The second piece 404 may additionally include spill-over edges 504 that circumferentially surround the outlets 212 of one or more of the helical passages 104. Horizontal baffles and spill-over edges are included in the multiplex inertial filter 100 to physically isolate helices. The isolation increases capture efficiency while reducing crosstalk among helical passages 104. An edge height 506 of the spill-over edges 504 may be less than a baffle height 508 of the horizontal baffles 502. The spill-over edges 504 may increase a holding capacity of the multiplex inertial filter 100 for particulate matter that is separated from an airflow by the helical passages 104. The spill-over edges 504 may collect accumulated particles and prevent captured particles from falling out of the multiplex inertial filter 100 during 1-g operations.

The multiplex inertial filter 100 may optionally include an air bypass baffle 514 in some configurations, such as is shown in FIG. 5. The air bypass baffle 514 may be positioned between the second piece 404 and the first piece 402 of the housing 102. The air bypass baffle 514 may include an array of through-holes 510 that are positioned in axial alignment with the array of helical passages 104 (e.g., with respect to the y-axis). In an assembled state of the configuration 500, each helical passage 104 may pass through a through-hole 510 of the array of through-holes 510. Horizontal baffles 502 of the air bypass baffle 514 are also provided to segregate sections of the hollow internal structure 408 such that air may not bypass the helical passages 104. The air bypass baffle 514 is configured to isolate flow of liquid, gas, and/or solids in the direction of flow through the helical passages 104. The air bypass baffle 514 may include horizontal baffles 502 having the same or a different configuration than the horizontal baffles 502 of the second piece 404 of the housing 102. The horizontal baffles 502 of the air bypass baffle 514 segment the hollow internal structure 408 into individual regions surrounding each helical passage 104 that fluidly separate each helical passage 104 from other helical passages 104 of the array of helical passages 104. A second baffle height 512 of the horizontal baffles 502 of the air bypass baffle 514 and the first baffle height 508 of the horizontal baffles 502 of the second piece 404 of the housing 102 may be sized such that the horizontal baffles 502 of the air bypass baffle 514 and the horizontal baffles 502 of the second piece 404 of the housing 102 stack vertically around the array of helical passages 104 within the height 108 of the multiplex inertial filter 100.

The horizontal baffles 502 and spill-over edges 504 may enhance capture mechanisms of the multiplex inertial filter 100 by reducing cross-talk and interference between helices. The horizontal baffles 502 and spill-over edges 504 are configured to increase particle collection by the filter. The horizontal baffles 502 act as isolation walls to fluidically isolate helical passages 104 of the array of helical passages 104, and prevent passage of particles among helical passages 104. Each spill-over edge 504 may at least partially surround a helical passage 104 of the array of helical passages 104. Each helical passage 104 may thus be isolated from other helical passages 104 by horizontal baffles 502 of the air bypass baffle 514, horizontal baffles 502 of the second piece 404 of the housing 102, and the spill-over edge 504. Vias or other types of connecting channels may be added to the multiplex inertial filter 100 (e.g., to the second piece 404 of the housing 102 and/or to the air bypass baffle 514) for continued draining. In this way, the air bypass baffle 514 and the second piece 404 of the housing 102 may increase filter efficiency and total filter loading capacity of the multiplex inertial filter 100.

Overall, the multiplex inertial filter 100 described herein provides several advantages over existing designs. Conventional designs for inertial filters, such as a porous droplet filter with an array of helical through-holes may also be configured to induce centrifugal forces on an inertially drifting liquid droplet. However, helical through-holes (e.g., passages) of the conventional array of helical through-holes are formed with a continuous outer wall that extends from an inlet of a helical passage to an outlet of the helical passage. Droplets that collide with a wall of the helical passage coalesce with hydrophilic filter media positioned at the outlet, and are wicked and/or pumped away from the helical passage. Solid particulates inertially separate in a similar inertial manner as liquid droplets, where solid particulates become wall bound within the helical pores. For small concentrations of solid particulates and for short time periods of use of the multiplex inertial filter, a buildup of particulates within the helical pores may present a negligible impact to filter performance and flow resistance. However, at larger concentrations, the buildup of particulates in the helical passages may reduce a filtration ability of the filter. Separation of liquid and particulate matter by conventional inertial filters generally operate in a binary manner where the liquid and particulate matter are either separated or not separated. The conventional multiplex inertial filters may not provide further filtering of the liquid and/or particulate matter. The particulate matter may include particulates of different sizes and shapes, and conventional multiplex inertial filters may not separate the different sizes and shapes of particulates from each other.

The multiplex inertial filter 100 includes no moving parts, maintains low constant pressure losses with increased particulate separation, and consumes no additional power due to its passive separation method. This method of solid, liquid, and/or gas separation leverages motive fluid streams, geometric flow components, and capillary/wicking forces in the case of liquids. Manufacturing material restrictions (e.g., demanded by three-dimensional (3D) printing methods) that are tied to absorbency/wetting may be removed, while retaining precise control of helical geometry. The multiplex inertial filter 100 is thus configured to separate and contain particulates. In further examples, the multiplex inertial filter 100 may include tapering slot dimensions, tapering pore dimensions, internal baffles, reduced pass-through between helical passages, electrically charged surfaces to enhance particle attraction and collection, and other features.

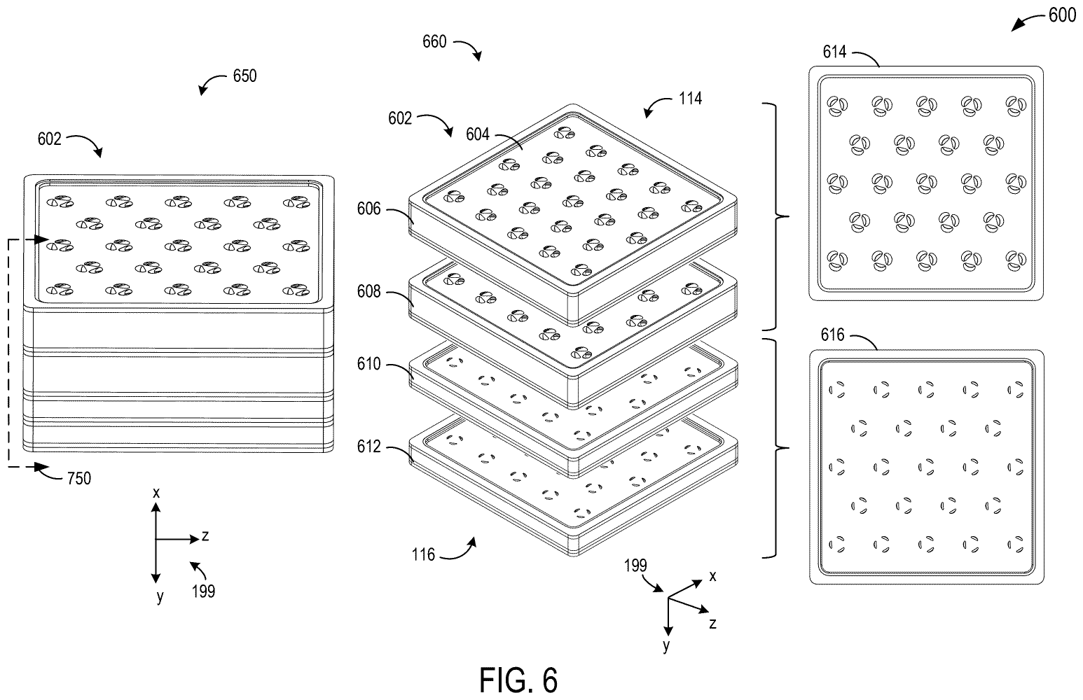

Multiple of the multiplex inertial filter 100 may be stacked or otherwise aligned in a stepwise configuration to form a filter system. FIG. 6 shows views 600 of an example filter system 602 that includes multiple configurations of the multiplex inertial filter 100. The filter system 602 is shown in an assembled configuration 650 and an exploded view 660. The filter system 602 comprises two or more multiplex inertial filters, and is configured to separate and contain particulates in a staged manner to capture increasingly smaller particles. For example, the filter system 602 may comprise a stack of multiplex inertial filters 100, where each multiplex inertial filter comprises an array of helical passages, where each helical passage of the array of helical passages includes an open slot in a wall of the helical passage, and where the open slot fluidly couples a flow path of the helical passage to the hollow internal structure of the housing. A first multiplex inertial filter at the first side 114 of the filter system 602 has a largest pore diameter of a helical passage, and each multiplex inertial filter of the filter system 602 has a progressively smaller pore diameter compared to an immediately preceding multiplex inertial filter, moving from the first side 114 to the second side 116.

The filter system 602 includes an impaction plate 604, a first stage 606, a second stage 608, a third stage 610, and a fourth stage 612. The impaction plate 604 may be the second piece 404 of the housing 102 of a first multiplex inertial filter (e.g., the multiplex inertial filter 100). The first stage 606 may be the first multiplex inertial filter, the second stage 608 may be a second multiplex inertial filter, the third stage 610 may be a third multiplex inertial filter, and the fourth stage 612 may be a fourth multiplex inertial filter. In other filter system configurations, the filter system may include more than, less than, and/or a different configuration of multiple multiplex inertial filters 100, without departing from the scope of the present disclosure.

Each of the first stage 606, the second stage 608, the third stage 610, and the fourth stage 612 may be examples of the multiplex inertial filter 100. The first stage 606 and the second stage 608 may be a first configuration 614 of the multiplex inertial filter 100 wherein the helical passages 104 have a first configuration. For example, the first configuration 614 may include helical passages 104 with dₚ=0.3 cm and P=1.27 cm. The third stage 610 and the fourth stage 612 may be a second configuration 616 of the multiplex inertial filter 100 wherein the helical passages 104 have a second configuration that is different from (e.g., each helical passage 104 may be smaller than helical passages of) the first configuration. For example, the second configuration 616 may include helical passages 104 with dₚ=0.1 cm and P=0.6 cm. The first configuration 614 and the second configuration 616 may include the same number of helical passages 104, which may be arranged in a same spatial distribution such that stacking of multiplex inertial filters 100 having the first configuration 614 and the second configuration 616 enables uninterrupted flow through from the first side 114 to the second side 116 of the filter system 602.

The first stage 606 and the second stage 608 may be configured to filter particles of the same size. The third stage 610 and the fourth stage 612 may be configured to filter particles of the same size. The third stage 610 and the fourth stage 612 may filter particles of a different size than the first stage 606 and the second stage 608. For example, the third stage 610 and the fourth stage 612 may be configured to filter smaller particles than the first stage 606 and the second stage 608. In this way, the filter system 602 may separate multiple sizes of particles from a liquid and/or gas flow, and may further separate particles by size.

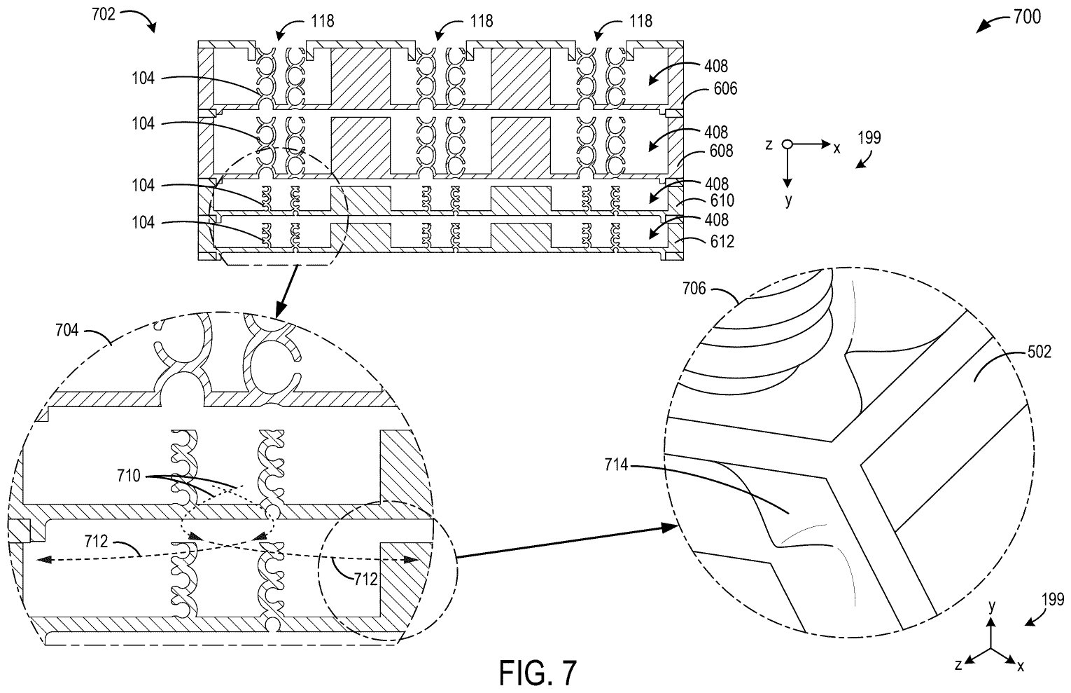

FIG. 7 shows a particle capture capacity of the multiplex inertial filters of the filter system 602 of FIG. 6 (e.g., the first stage 606, the second stage 608, the third stage 610, and the fourth stage 612). Images 700 of FIG. 7 are cross-sections of the filter system 602 of FIG. 6, sectioned along the line 750 of FIG. 6 (e.g., in the y-z plane).

A first view 702 of the cross-section shows three helical passages of each of the first stage 606, the second stage 608, the third stage 610 and the fourth stage 612. A multi-phase medium (e.g., liquid-solid, gas-solid, etc.) enters the filter system 602 at the inlets 118 of each helical passage 104 of the first stage 606 at the first side 114 (e.g., at the impaction plate 604).

Distinct particle accumulation zones may occur within the filter system 602, particularly in the third stage 610 and the fourth stage 612. This is attributed to step transitions between the multiplex inertial filters of the filter system 602, where a highly vortical flow leaves one filter (e.g., the first stage 606) and enters the next (e.g., the second stage 608). The path of a particle is illustrated by dashed arrows of a first detailed view 704 of the cross-section. A first pair of dashed lines 710 show the vortical flow forced by the helical path through the filter face. A second pair of dashed lines 712 show an approximate radial path the heavy particle takes once it has entered the cavity of the next filter, leading to impaction onto the internal walls and potential buildup of particulate matter 714, as shown in a second detailed view 706 of FIG. 7.

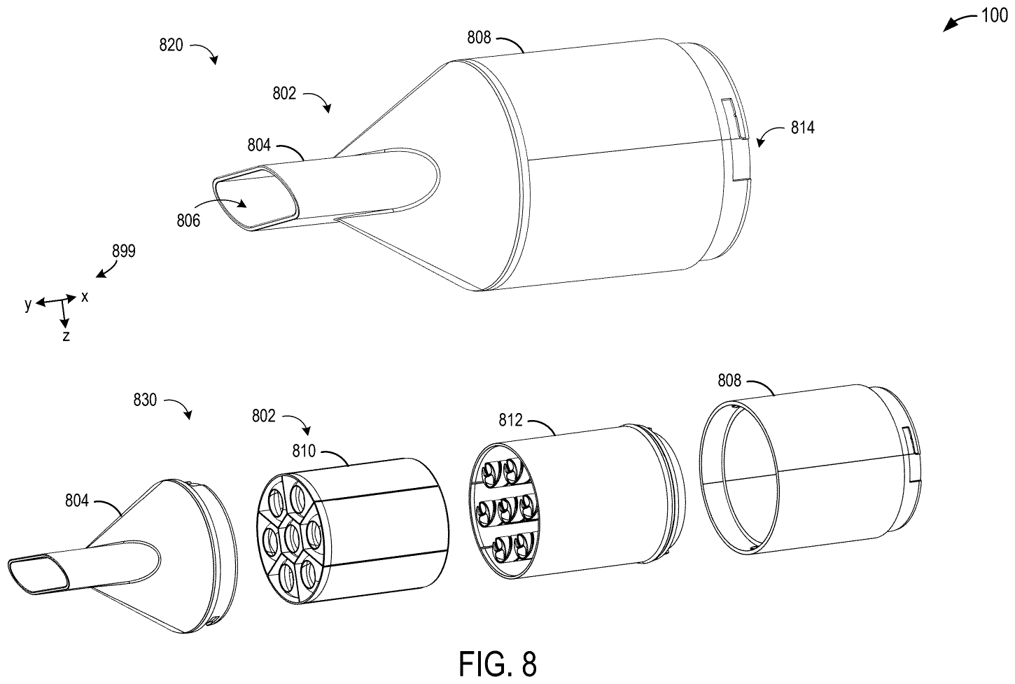

One or more multiplex inertial filters as described herein may be implemented in a device to provide particle filtering functionality to the device. FIGS. 8-10 show an example vacuum device 802 that may have a multiplex inertial filter 812 included therein to filter and capture particles in material that is sucked up by the vacuum device 802. FIG. 8 shows a perspective view 820 and an exploded view 830 of the vacuum device 802 with the multiplex inertial filter implemented therein. An axis system 899 is provided in FIGS. 8-10 for reference. The z-axis may be a vertical axis, the x-axis may be a lateral axis (e.g., horizontal axis), and the y-axis may be a longitudinal axis, in one example. However, the axes may have other orientations, in other examples.

The vacuum device 802 includes a nozzle 804 with an inlet 806 via which multiphase flow enters the vacuum 802 (e.g., is sucked in by a vacuum force of the vacuum device 802), a body 808, a sleeve 810, and the multiplex inertial filter 812. The sleeve 810 is configured to circumferentially surround the multiplex inertial filter 812, and may be an example of the second piece 404 of the housing 102 of the multiplex inertial filter 812. In the example of FIGS. 8-10, the multiplex inertial filter 812 has a cylindrical shape, rather than rectangular, and other shapes are possible without departing from the scope of the present disclosure. For example, the sleeve 810 includes baffles and domed channels configured to circumferentially surround and fluidly separate each helical passage from other helical passages. The body 808 may circumferentially surround the sleeve 810, and may be removably coupled to the nozzle 804. The vacuum device 802 may be coupled to a power source at a second end 814 of the vacuum device 802 (e.g., at the body 808, opposite the nozzle 804) The power source may be configured to generate a vacuum to pull material through the multiplex inertial filter 812.

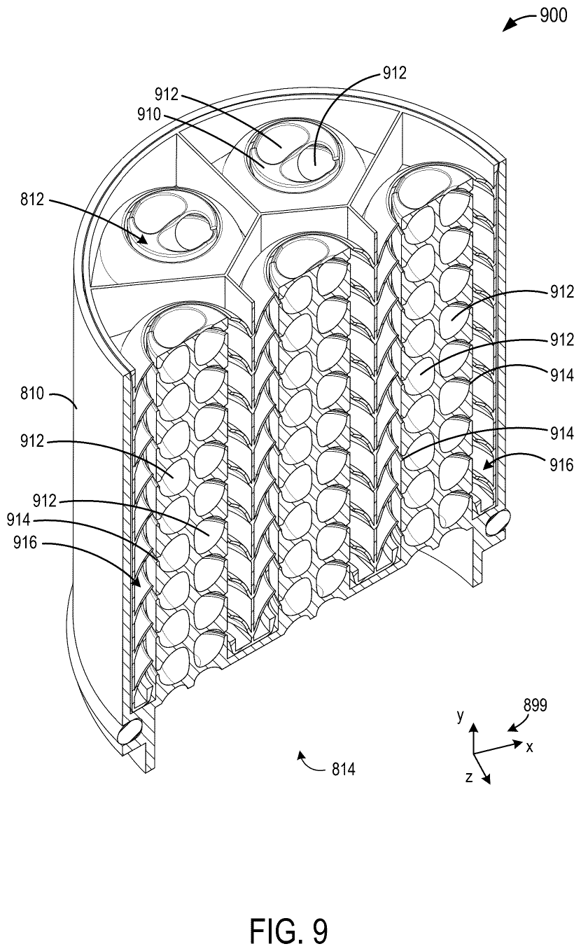

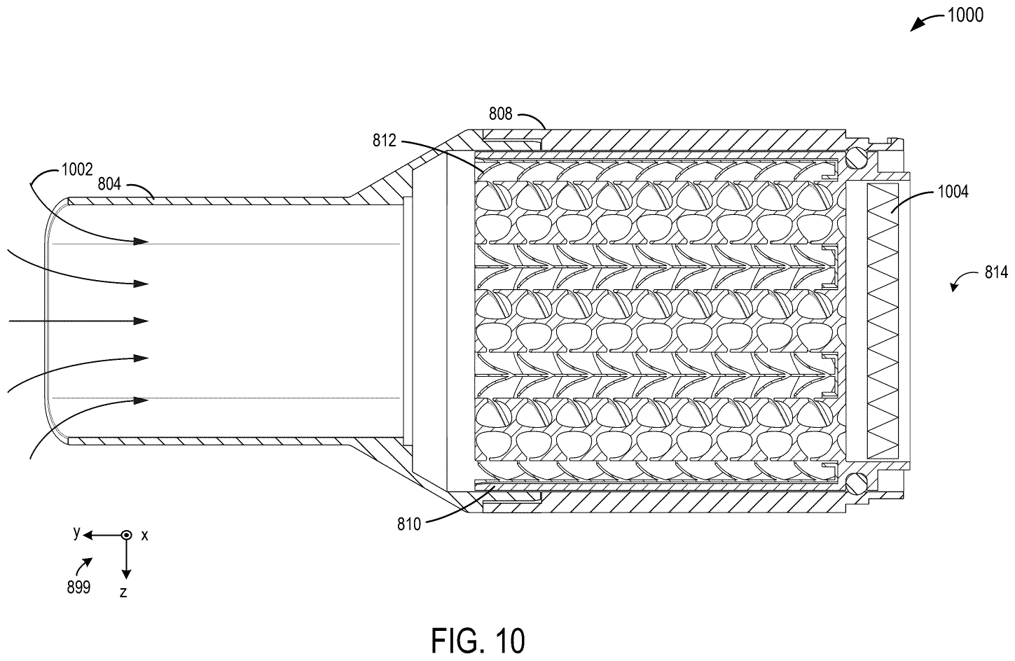

FIG. 9 shows an isometric cross-section 900 of the multiplex inertial filter 812 positioned in the sleeve 810 of the vacuum device 802. FIG. 10 shows a side cross-section view 1000 of the vacuum device 802. FIGS. 9 and 10 are described simultaneously herein. In the example provided herein, the multiplex inertial filter 812 includes multiple bi-helical units 910, where each bi-helical unit includes two flow paths 912. The flow paths of the bi-helical units are configured as described above with respect to the flow paths of the multiplex inertial filter 100. For example, each flow path includes an open slot 914 in walls thereof to fluidly couple the flow path to the hollow internal structure 916 of the housing (e.g., including the sleeve 910) of the multiplex inertial filter 812. The multiplex inertial filter 812 may include multiple tri-helical units, single helix units, and so on, without departing from the scope of the present disclosure. Material including particulate matter, gas, and in some examples liquid, enters the vacuum device 802 via the nozzle 804, indicated by a series of arrows 1002 of FIG. 10, and passes through the multiplex inertial filter 812 in the body 808. The multiplex inertial filter may be configured as a slotted corkscrew filter, and filters particles in the material out of the flow path. In some examples, the vacuum device 802 optionally includes a reduced area high efficiency particulate air (HEPA) backup filter 1004 at the second end 814 of the vacuum device 802 to capture particulates not captured by the multiplex inertial filter 812.

The multiplex inertial filter 812 may be an example of the multiplex inertial filter 100 of FIGS. 1-7. As described herein, the multiplex inertial filter 812, includes an open slot added to walls of the helical passages, the hollow internal structure that allows for separation, capture and containment of particulate matter into the empty volume, horizontal baffle and spill-over edge partitions to isolate helices and prevent crosstalk, variation in the helical passage geometry, internal baffles to restrict air flow bypass through the internal hollow cavity, spill-over edges to assure high particle load retention, and the stackable/staged nature of multiple multiplex inertial filters.

In this way, multiplex inertial filter may perform liquid-gas, solid-gas, liquid-liquid (e.g., for immiscible liquids via selective packing material configured to absorb liquid of a first wetting and reject liquid of a second, different wetting), and solid-liquid-gas phase separations for droplets/particles of a wide range of length-scales including centimeter to micrometer sizes. Furthermore, the multiplex inertial filter advantageously has no moving parts, low pressure losses, constant pressure drop, and no additional power consumption due to its passive separation method utilizing motive fluid streams and geometric flow components.

The disclosure also provides support for a multiplex inertial filter, comprising: a housing with a hollow internal structure, and an array of helical passages, where each helical passage of the array of helical passages includes an open slot in a wall of a helical passage, and the open slot fluidly couples a helical flow path of the helical passage to the hollow internal structure of the housing. In a first example of the system, each helical passage is a tri-helix unit with three helical flow paths. In a second example of the system, optionally including the first example, each wall of the helical flow path has an open slot. In a third example of the system, optionally including one or both of the first and second examples, the system further comprises: an absorbent material positioned in the hollow internal structure. In a fourth example of the system, optionally including one or more or each of the first through third examples, the system further comprises: a reactive material positioned in the hollow internal structure. In a fifth example of the system, optionally including one or more or each of the first through fourth examples, the housing is formed of a first piece with the array of helical passages extending therefrom, and a second piece that is configured to mate with the first piece and has an array of helical through-holes that complement the array of helical passages. In a sixth example of the system, optionally including one or more or each of the first through fifth examples, the array of helical passages and the first piece of the housing are formed as a single, continuous piece. In a seventh example of the system, optionally including one or more or each of the first through sixth examples, each helical passage of the array of helical passages are individual pieces that are inserted into and/or coupled to the first piece of the housing to form the array of helical passages. In an eighth example of the system, optionally including one or more or each of the first through seventh examples, the second piece includes horizontal baffles that segment the hollow internal structure into individual regions surrounding each helical passage that fluidly separate each helical passage from other helical passages of the array of helical passages. In a ninth example of the system, optionally including one or more or each of the first through eighth examples, the second piece includes an array of spill-over edges that surround each helical passage. In a tenth example of the system, optionally including one or more or each of the first through ninth examples, a width of the open slot is variable and a diameter of the helical flow path is variable for each turn of the helical passage. In an eleventh example of the system, optionally including one or more or each of the first through tenth examples, a width of the open slot is constant and a diameter of the helical flow path is variable for each turn of the helical passage. In a twelfth example of the system, optionally including one or more or each of the first through eleventh examples, a width of the open slot is variable and a diameter of the helical flow path is constant for each turn of the helical passage.

The disclosure also provides support for a filter system, comprising: a stack of multiplex inertial filters comprising a first multiplex inertial filter and a second multiplex inertial filter stacked such that outlets of the first multiplex inertial filter are coaxially aligned with inlets of the second multiplex inertial filter, wherein each of the first multiplex inertial filter and the second multiplex inertial filter comprises an array of helical passages including an open slot in a wall of a helical passage that fluidly couples a flow path of the helical passage to a hollow internal structure of a housing of the multiplex inertial filter, and where a pore diameter of the helical passages of the first multiplex inertial filter is greater than the pore diameter of the helical passages of the second multiplex inertial filter. In a first example of the system, a multiplex inertial filter of the stack of multiplex inertial filters includes horizontal baffles that segment the hollow internal structure into individual regions surrounding each helical passage that fluidly separate each helical passage from other helical passages of the array of helical passages. In a second example of the system, optionally including the first example, each multiplex inertial filter of the stack has a progressively smaller pore diameter compared to an immediately preceding multiplex inertial filter.

The disclosure also provides support for a vacuum device, comprising: a nozzle, a sleeve with a hollow internal structure, a multiplex inertial filter comprising an array of helical passages, where each helical passage of the array of helical passages includes an open slot in a wall of the helical passage, and the open slot fluidly couples a helical flow path of the helical passage to the hollow internal structure, and a body configured to circumferentially surround the sleeve and the multiplex inertial filter, and to couple to the nozzle. In a first example of the system, the sleeve comprises baffles and domed channels configured to circumferentially surround and fluidly separate each helical passage from other helical passages. In a second example of the system, optionally including the first example, the system further comprises: a power source coupled to the body at a second end of the vacuum device, where power source is configured to generate a vacuum to pull material through the multiplex inertial filter. In a third example of the system, optionally including one or both of the first and second examples, the system further comprises: a high efficiency particulate air filter positioned between the multiplex inertial filter and the body at a second end of the vacuum device.

FIGS. 1-10 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A multiplex inertial filter, comprising:
a housing with a hollow internal structure; and
an array of helical passages, where each helical passage of the array of helical passages includes an open slot in a wall of a helical passage, and the open slot fluidly couples a helical flow path of the helical passage to the hollow internal structure of the housing.

2. The multiplex inertial filter of claim 1, where each helical passage is a tri-helix unit with three helical flow paths.

3. The multiplex inertial filter of claim 1, wherein each wall of the helical flow path has the open slot.

4. The multiplex inertial filter of claim 1, further comprising an absorbent material positioned in the hollow internal structure.

5. The multiplex inertial filter of claim 1, further comprising a reactive material positioned in the hollow internal structure.

6. The multiplex inertial filter of claim 1, wherein the housing is formed of a first piece with the array of helical passages extending therefrom, and a second piece that is configured to mate with the first piece and has an array of helical through-holes that complement the array of helical passages.

7. The multiplex inertial filter of claim 6, wherein the array of helical passages and the first piece of the housing are formed as a single, continuous piece.

8. The multiplex inertial filter of claim 6, wherein each helical passage of the array of helical passages are individual pieces that are inserted into and/or coupled to the first piece of the housing to form the array of helical passages.

9. The multiplex inertial filter of claim 6, wherein the second piece includes horizontal baffles that segment the hollow internal structure into individual regions surrounding each helical passage that fluidly separate each helical passage from other helical passages of the array of helical passages.

10. The multiplex inertial filter of claim 6, wherein the second piece includes an array of spill-over edges that surround each helical passage.

11. The multiplex inertial filter of claim 1, wherein a width of the open slot is variable and a diameter of the helical flow path is variable for each turn of the helical passage.

12. The multiplex inertial filter of claim 1, wherein a width of the open slot is constant and a diameter of the helical flow path is variable for each turn of the helical passage.

13. The multiplex inertial filter of claim 1, wherein a width of the open slot is variable and a diameter of the helical flow path is constant for each turn of the helical passage.

14. A filter system, comprising:
a stack of multiplex inertial filters comprising a first multiplex inertial filter and a second multiplex inertial filter stacked such that outlets of the first multiplex inertial filter are coaxially aligned with inlets of the second multiplex inertial filter, wherein each of the first multiplex inertial filter and the second multiplex inertial filter comprises an array of helical passages including an open slot in a wall of a helical passage that fluidly couples a flow path of the helical passage to a hollow internal structure of a housing of the respective multiplex inertial filter; and where
a pore diameter of the helical passages of the first multiplex inertial filter is greater than the pore diameter of the helical passages of the second multiplex inertial filter.

15. The filter system of claim 14, wherein a multiplex inertial filter of the stack of multiplex inertial filters includes horizontal baffles that segment the hollow internal structure into individual regions surrounding each helical passage that fluidly separate each helical passage from other helical passages of the array of helical passages.

16. The filter system of claim 14, wherein each multiplex inertial filter of the stack has a progressively smaller pore diameter compared to an immediately preceding multiplex inertial filter.

17. A vacuum device, comprising:
a nozzle;
a sleeve with a hollow internal structure;
a multiplex inertial filter comprising an array of helical passages, where each helical passage of the array of helical passages includes an open slot in a wall of the helical passage, and the open slot fluidly couples a helical flow path of the helical passage to the hollow internal structure; and
a body configured to circumferentially surround the sleeve and the multiplex inertial filter, and to couple to the nozzle.

18. The vacuum device of claim 17, wherein the sleeve comprises baffles and domed channels configured to circumferentially surround and fluidly separate each helical passage from other helical passages.

19. The vacuum device of claim 17, further comprising a power source coupled to the body at a second end of the vacuum device, where power source is configured to generate a vacuum to pull material through the multiplex inertial filter.

20. The vacuum device of claim 17, further comprising a high efficiency particulate air filter positioned between the multiplex inertial filter and the body at a second end of the vacuum device.
